(19) United States
(12) Patent Application Publication
(10) Pub. No.: US 2007/0283571 A1
(43) Pub. Date: Dec. 13, 2007

(54) Scissors

(75) Inventor: Klaus Moser, Emmingen-Liptingen (DE)

Correspondence Address: AKERMAN SENTERFITT, P.O. BOX 3188, WEST PALM BEACH, FL, 33402-3188, US

(73) Assignee: GIMMI GMBH, TUTTLINGEN (DE)

(21) Appl. No.: 11/575,561

(22) PCT Filed: Sep. 14, 2005
(86) PCT No.: PCT/EP05/09874

§ 371 Date: Mar. 19, 2007

(30) Foreign Application Priority Data
Sep. 20, 2004 (DE) 20 2004 014 750.5

(51) Int. Cl. B26B 13/06

(52) U.S. Cl. 30/257

(57) ABSTRACT

The invention provides scissors, having two scissors parts (12, 14), mounted to counter-rotate about a rotational axis (16), which transform into a grip element (12a, 14a) through a closure contact bevel (12d, 14d) and a counter surface (12c, 14c) and have, at the other free axial end thereof, a working end (18), provided with scissors elements (12b, 14b), whereby the working end (18) is angled at an angle (a) in the plane of the scissors (10) from the axis of the scissors parts (12, 14). The distance (L1) from the rotational axis (16) to the closure contact bevel (12d, 14d) of at least one of the scissors parts (12, 14) is greater than the distance (13) from the rotational axis (16) to the distal end of the scissors elements (12b, 14b).

The invention relates to a scissors according to the pre-characterizing portion of patent claim 1.

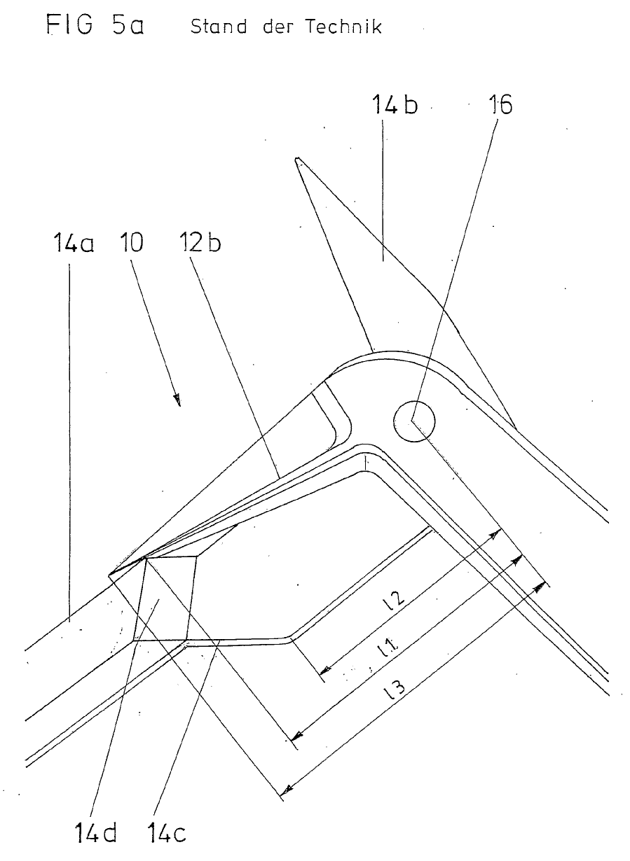

FIGS. 5 and 5a show a scissors 10 according to the state of the art with a first scissors part 12 and second scissors part 14, which are connected to each other rotatable about a rotation axis 16. The scissors parts 12, 14 transition along one free axial end, via a diagonal contact bevel 12d, 14d and a counter surface 12c, 14c, into a grip element 12a, 14a. In the other free axial end of the scissors parts 12, 14 there is provided a working end 18 equipped with scissors elements 12b, 14b. If the two scissors parts 12, 14 are rotated about the axis 16 and completely closed, the counter surface 14c of the scissors part 14 comes to lie against the diagonal contact bevel 12d of the scissors part 12 and the counter surface 12c of the scissors part 13 on the diagonal contact bevel 14d of the scissors part 14, separated however by only a very narrow gap. Starting at the contact surface of the two scissors parts 12, 14 the diagonal contact bevels 12d, 14d as well as the counter surfaces 12c, 14c run outwardly diagonally to the axis of the scissors 10 and form an acute angle with the section of the axis of the scissors 10 facing the direction of the work end 18.

In the following the distance L1 between the rotation axis 16 and the diagonal contact bevel 12d, 14d is defined as the distance L1 from the rotation axis 16 to the intersection of the diagonal contact bevel 12d, 14d with the outside of the scissors part 12, 14. The distance L2 between the rotation axis 16 and the counter surface 12c, 14c is defined as the distance L2 from the rotation axis to the intersection of the counter surface 12c, 14c with the outside of the scissors part 12, 14.

Scissors are known in surgery, in which the working end 18 is angled or bent in the plane of the scissors 10 by an angle a from the axis of the scissors parts 12, 14, and preferably 20° to 160°.

The scissors elements 12b, 14b of the working end 18 terminate in a pointed distal end and are thus particularly susceptible to damage. Under load these distal ends of the scissors elements 12b, 14b easily break off. In FIG. 5a a situation of load of this type is shown, which can occur when the two scissors parts 12, 14 are opened particularly widely, so that the scissors element 12b of the first scissors part 12 contacts the grip element 14a of the second scissors part 14.

The task of the invention lies in providing a scissors in which the distal ends are protected against unnecessary loads, which could lead to damage.

The task is inventively solved by a scissors having the characteristics of the characterizing portion of patent claim 1.

Advantageous embodiments of the invention are set forth in the dependent claims.

In accordance with the invention the distance from the rotation axis to the diagonal closure contact bevel of at least one of the scissors parts is greater than the distance from the rotation axis to the distal end of the scissors elements.

This determines, that even in large opening angles of the two scissors parts relative to each other, the distal end of the scissors element of the first scissors part does not abut or contact the grip element of the other scissors part; rather, it can pass thereby. The sensitive distal ends of the scissors elements are thus protected against breaking off upon opening of the scissors too far and abutment on the grip element of the other scissors part.

Preferably the distance of the rotation axis to the diagonal closure contact bevel in both linkage parts is greater than the distance from the rotation axis to the distal end of the scissors elements, in order to correspondingly protect both scissors elements.

In one advantageous further development of the invention the distance from the rotation axis to a counter surface of the grip element is smaller than the distance or distance from the rotation axis to the diagonal bevel contact surface. Such a design is particularly useful when, in the manufacture of the scissors parts, standardized blanks or preforms according to the state of the art are employed, of which the distance from the rotation axis to the closure contact bevel and therewith likewise to the counter surface is smaller than the distance from the rotation axis to the distal end of the scissors elements. In order to use this type of blank for manufacturing the inventive scissors, the diagonal closure bevels are displaced parallel to the proximal end of the linkage part by removing commensurate material from the blank. The closure contact bevels are displaced by a certain amount parallel to the proximal end of the scissors parts so far until the distance of the rotation axis to the closure contact bevel is greater than the distance from the rotation axis to the distal end of the scissors element. In this case the distance from the rotation axis to the counter surface of the grip element remains however by a certain amount smaller than the distance from the rotation axis to the closure contact bevel. In this manner, in particularly simple manner, conventional blanks or preforms can be used in the manufacture of the inventive scissors.

In one alternative preferred embodiment of the invention the distance from the rotation axis to the counter surface corresponds approximately to the distance from the rotation axis to the closure contact bevel of the scissors part. Therewith both distances are greater than the distance from the rotation axis to the distal end of the scissors element. For manufacturing, no blanks according to the state of the art can be employed, therefore however in the closed condition of the scissors the counter surfaces respectively lie upon the closure contact bevels.

The angle by which the work end is angled is preferably 20° to 160°. Particularly preferred is when the work end is angled or bent by 90° to 135° in the plane of the scissors from the axis of the scissors parts. With smaller angles the problem of damage of the distal ends of the scissors element only rarely occurs, since to reach this stage a significantly greater opening angle of both scissors parts would be necessary, which however is seldom achieved.

The invention will be described in greater detail on the basis of the following illustrative embodiment shown in the figures. There is shown in:

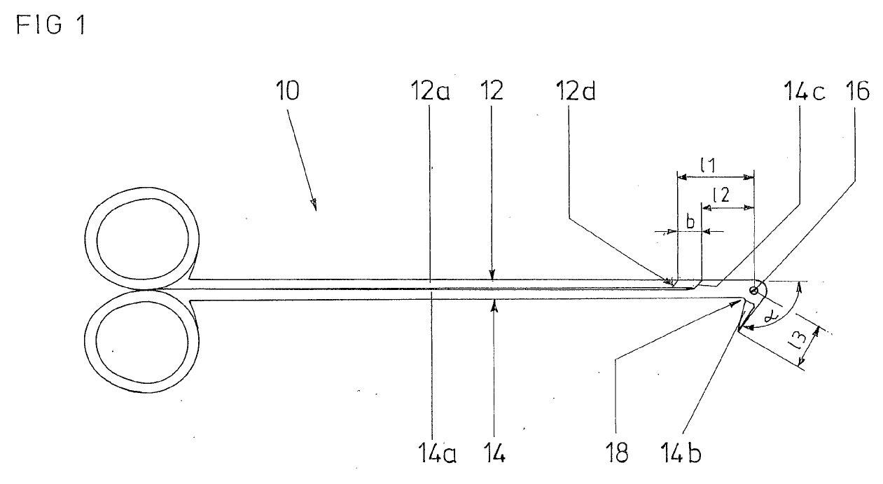

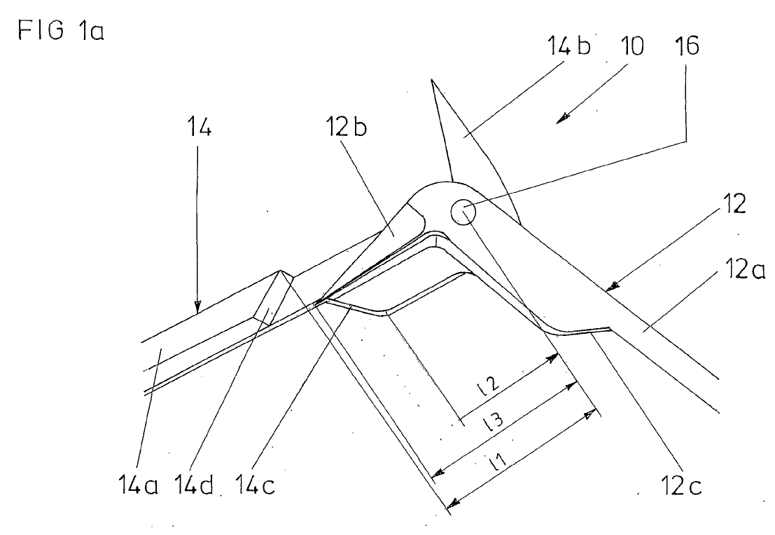

FIG. 1 A first embodiment of a inventive scissors,

FIG. 1a the scissors from FIG. 1 in the opened condition,

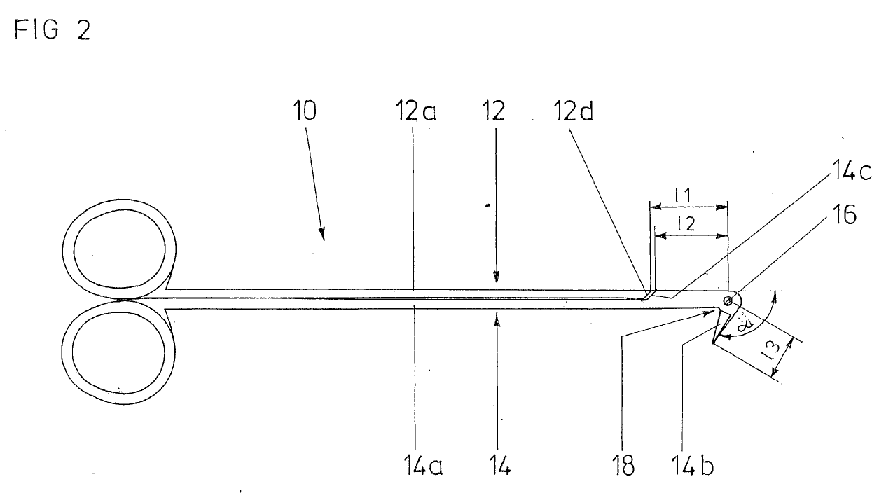

FIG. 2 a second embodiment of the invention,

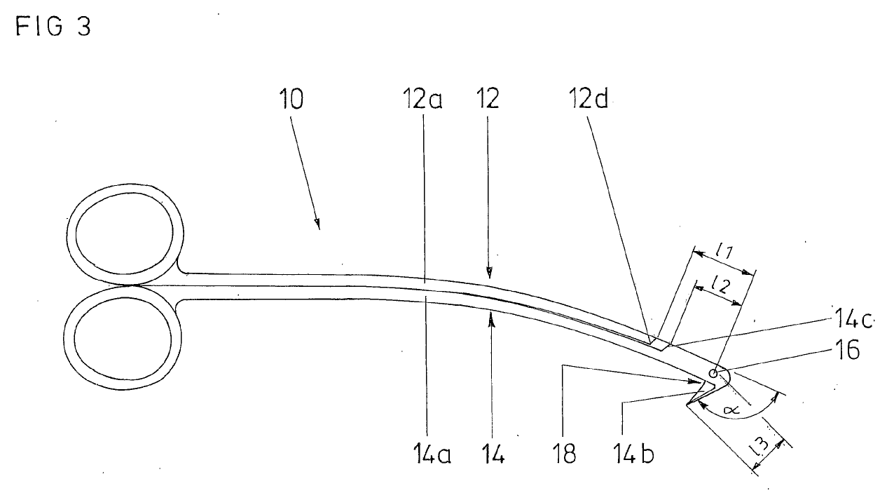

FIG. 3 a third embodiment of the invention,

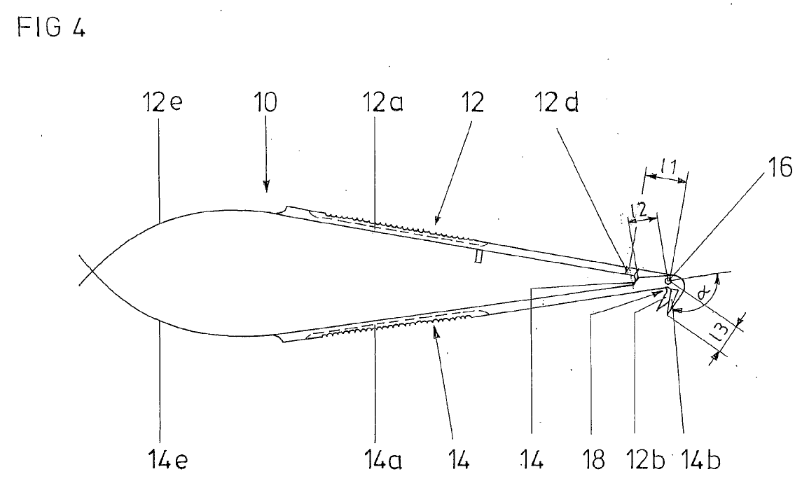

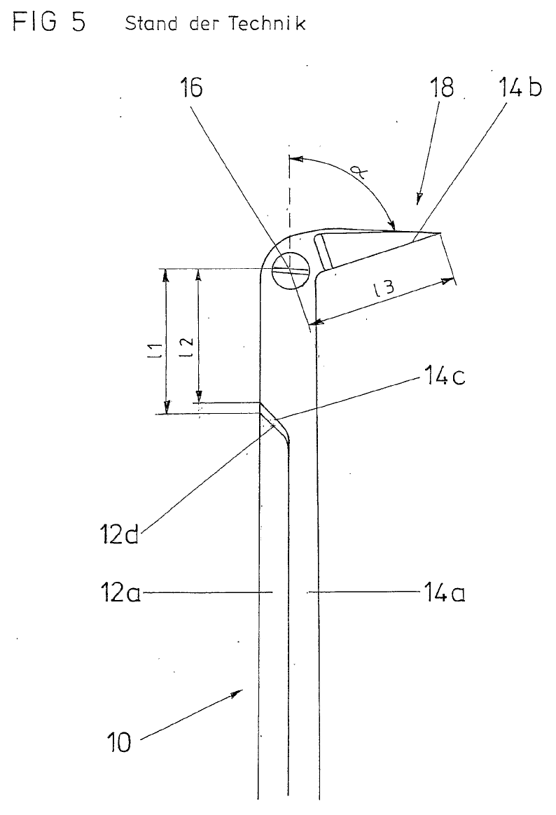

FIG. 4 a fourth embodiment of the invention,

FIG. 5 an embodiment of the scissors according to the state of the art, and

FIG. 5a the scissors according to FIG. 5 in the opened condition.

FIG. 1 shows a first embodiment of an inventive scissors 10 with a first scissors part 12 and a second scissors part 14, which are mounted rotatable to each other about a rotation axis 16. The two scissors parts 12, 14 exhibit on a free axial end on one side of the rotation axis 16 respectively one scissors element 12b, 14b, which together form a work end 18. The work end 18 is angled in the plane of the scissors 10 by an angle α, which in this embodiment is approximately 125°, from the axis of the scissors parts 12, 14. The free axial ends of the scissors parts 12, 14 on the other side of the rotation axis 16 transition via a counter surface 12c, 14c into a grip element 12a, 14a. The grip elements 12a, 14a are in the form of grip elements of conventional scissors.

The scissors parts 12, 14 respectively exhibit one closure bevel 12d, 14d, which, beginning with the counter surface 14c, 12c of the respective other scissors part 12, 14, is displaced by an amount b along the axis of the scissors part 12, 14 parallel to the proximal end of the scissors 10. For this, beginning with a blank, in which the closure contact bevels 12d, 14d come to lie directly on the counter surfaces 12c, 14c (see for example FIGS. 5 and 5a), material is removed, so that the closure contact bevels 12d, 14d are displaced parallel to the proximal end of the scissors parts 12, 14. By this displacement of the closure contact bevels 12d, 14d the distance L1 from the rotation axis 16 to the closure contact bevels 12d, 14d is greater than the distance L3 between the rotation axis 16 and the distal end of the scissors elements 12b, 14b. The distance L2 from the rotation axis 16 to the counter surfaces 12c, 14c remains smaller in this embodiment of the invention than the distance L3 from the rotation axis 16 to the distal ends of the scissors elements 12b, 14b (see FIG. 1a).

The advantage of an offset or displacement of the closure contact bevels 12d, 14d of this type can be seen in FIG. 1a in which the inventive scissors 10 is represented with opened scissors parts 12, 14. Since the distance L1 from the closure contact bevels 14b to the rotation axis 16 is greater than the distance L3 from the rotation axis 16 to the distal end of the scissors element 12b, the scissors part 12 with the scissors element 12b can be opened wide without the distal end of the scissors element 12b abutting or contacting against the grip element 14a of the scissors part 14 and the danger of the breaking off of the distal end of the scissors element 12b could exist, since the distal end of the scissors element 12b could rotate past the grip element 14a of the scissors part 14 (without contact, and thus without danger of breaking).

FIG. 2 shows a further embodiment of the invention in which the same parts are indicated with the same reference numbers as the first embodiment. The second embodiment differs from the embodiment of FIG. 1 only in that also the distance L2 from the counter surface 14c to the rotation axis 16 is greater than the distance L3 from the rotation axis 16 to the distal end of the scissors on the 12b, 14b. The distance L2 is approximately as large as the distance L1, so that the counter surfaces 14c can lie on the closure contact bevels 12d separated by only a very small gap. A scissors 10 of this type can not be produced from blanks in which the distance L1 and L2 is smaller than the distance L3, since in addition to displacement of the closure contact bevels 12d, 14d, for which material must be removed, also the counter surfaces 12c, 14c must be displaced relative to the proximal end, for which material must be added.

FIGS. 3 and 4 show two further embodiments of the invention, which differ from the embodiment shown in FIG. 1 only in the design of the grip elements 12a, 14a. The embodiment shown in FIG. 3 has grip elements 12a, 14a, which are slightly bent in order, depending upon the operating space, to more easily introduce the work end 18. The work end shown in FIG. 4 exhibits two grip elements 12a, 14a, which are held in the open position via two spring elements 12e, 14e, so that the scissors of the work and 18 can be closed against the force of the spring elements 12e, 14e by squeezing the grip elements 12a, 14a together.

### REFERENCE NUMBER LIST

10. Scissors
12. First scissors part
12a. Grip element
12b. Scissors element
12c. Counter surface
12d. Closure contact bevel
12e. Spring element
14. Second scissors part
14a. Grip element
14b. Scissors element
14c. Counter surface
14d. Closure contact bevel
14e. Spring element
16. Rotation axis
18. Work
L1 Spacing
L2 Spacing
L3 Spacing
α. Angle
b Amount

1. Scissors, comprising:
two scissors parts (12,14), which are mounted rotatable about a rotation axis (16), and which transition at one free axial end via a closure contact bevel (12d, 14d) and a counter surface (12c, 14c) into a grip element (12a, 14a) and which exhibit on the other free axial end a work end (18) equipped with scissors elements (12b, 14b),
wherein the work end (18) is angled in plane of the scissors (10) by an angle (α) from the axis of the scissors parts (12, 14),
wherein a distance (L1) from the rotation axis (16) to the closure contact bevel (12d, 14d) of at least one of the scissors parts (12, 14) is greater than a distance (L3) from the rotation axis (16) to a distal end of the scissors elements (12b, 14b).

2. The scissors according to claim 1, wherein the distance (L1) of the rotation axis (16) to the closure contact bevel (12d, 14d) for the two scissors parts (12, 14) is larger than the distance (L3) from the rotation axis (16) to the distal end of the scissors elements (12b, 14b).

3. The scissors according to claim 1, wherein a distance (L2) from the rotation axis (16) to the counter surface (12c, 14c) is smaller by an amount (b) than the distance (L1) from the rotation axis (16) to the closure contact bevel (12d, 14d).

4. The scissors according to claim 1, wherein the distance (L2) from the rotation axis (16) to the counter surface (12c, 14c) corresponds to approximately the distance (L1) from the rotation axis (16) to the closure contact bevel (12d, 14d).

5. The scissors according to claim 1, wherein the angle (α) is approximately 20° to 160°.

6. The scissors according to claim 1, wherein the angle (α) is approximately 90° to 130°.
